(19) United States
(12) Patent Application Publication
(10) Pub. No.: US 2005/0056056 A1
(43) Pub. Date: Mar. 17, 2005

(54) Healing micro cracks in a substrate

(76) Inventor: Marvin Glenn Wong, Woodland Park, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/665,083

(22) Filed: Sep. 16, 2003

(51) Int. Cl. C03C 15/00

(52) U.S. Cl. 65/28; 65/61; 65/65

(57) ABSTRACT

A method for healing cracks in a switch substrate is disclosed. The method includes heating the switch substrate to a temperature in the range between an annealing point and a softening point of the substrate, and then cooling the substrate. Also disclosed are a method for forming a channel plate, and a method for producing a switch.

### BACKGROUND

Channel or cavity features may be created in glass or ceramic by abrasive machining, for example, sandblasting. Sometimes it is desirable to apply other materials, for example, a layer of metal, to the channel or cavity features. Unfortunately, the adhesion of these other materials to the surfaces of the features may be compromised as a result of the roughness of the abraded surfaces. Similarly, the seal between the desired layer and the features may be compromised as a result of micro cracks formed beneath the features.

### SUMMARY

One aspect of the invention is embodied in a method for forming a channel plate. The method comprises abrading at least one channel in a substrate, heating the substrate to a temperature in the range between an annealing point and a softening point of the substrate, and then cooling the substrate.

Another aspect of the invention is embodied in a method for healing micro cracks in a switch substrate. The method comprises heating the substrate to a temperature in the range between an annealing point and a softening point of the substrate, and then cooling the substrate.

Yet another aspect of the invention is embodied in a switch. The switch is produced by abrading at least one channel in a first substrate, heating the first substrate until micro cracks in the at least one channel are healed, and then cooling the first substrate. The method continues with the steps of depositing seal belt metal layers on the at least one channel in the first substrate, aligning the at least one channel formed in the first substrate with at least one feature on a second substrate, and sealing at least a switching fluid between the first substrate and the second substrate.

### BRIEF DESCRIPTION OF THE DRAWINGS

Illustrative embodiments of the invention are illustrated in the drawings in which:

FIG. 1 illustrates a method for forming a channel plate;

FIG. 2 illustrates an exemplary plan view of a substrate with a photoresist;

FIG. 3 illustrates a cross-section of the substrate with a photoresist shown in FIG. 2;

FIG. 4 illustrates the patterning of a feature in the photoresist shown in the FIG. 3 cross-section;

FIG. 5 illustrates the sandblasting of a channel in the substrate in the FIG. 4 cross-section;

FIG. 6 illustrates the removal of unwanted portions of the photoresist shown in the FIG. 5 cross-section;

FIG. 7 illustrates the channel down orientation of the substrate of the FIG. 6 cross-section during heating;

FIG. 8 illustrates a plan view of a substrate with channels formed therein (i.e., a channel plate);

FIG. 9 illustrates a cross-section of the substrate with channels formed therein as shown in FIG. 8;

FIG. 10 illustrates a method for healing micro cracks in a switch substrate;

FIG. 11 illustrates a first exemplary embodiment of a switch; and

FIG. 12 illustrates a second exemplary embodiment of a switch.

### DETAILED DESCRIPTION

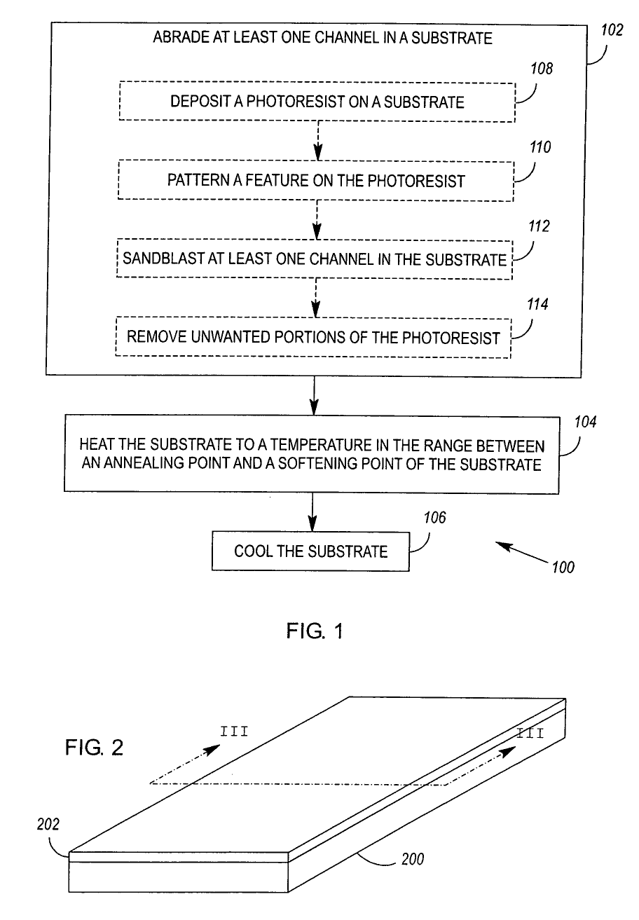

FIG. 1 illustrates a method 100 for forming a channel plate. Referring to FIGS. 1-6, the method commences with the step of abrading 102 at least one channel 500 in a substrate 200. For the purpose of this description, “channel” is defined to be any sort of groove, trough, pit or other feature that creates a recess extending below the uppermost surface of a substrate. The substrate 200 is then heated 104 to a temperature in the range between an annealing point and a softening point of the substrate 200. The substrate 200 is then cooled 106.

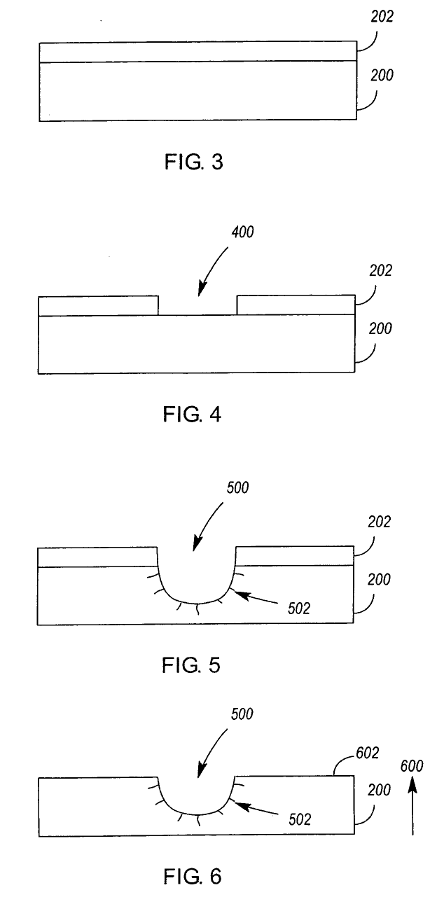

Referring to FIGS. 1-6, one exemplary method (FIG. 1) of abrading 102 comprises depositing 108 a photoresist 202 on the substrate 200 (FIGS. 2 and 3). The photoresist 200 may be deposited in a variety of ways. One way to deposit the photoresist 202 is to deposit the photoresist 202 on an entire surface of the substrate 200 (FIG. 3). Although the surface of the substrate 200 illustrated in FIGS. 2-6 is shown to be flat, it need not be. A feature 400 is patterned 110 on the photoresist 202 (FIG. 4). A channel 500 is abraded 102 at the location of the feature 400 (FIG. 5). The step of abrading 102 could comprise the method as set forth in steps 108-114 of FIG. 1 which includes depositing 108 a photoresist 202 (FIG. 2) on a substrate 200 (FIG. 3), patterning 110 a feature 400 on the photoresist 202 (FIG. 4), and sandblasting 112 at least one channel 500 in the substrate 200 (FIG. 5) and removing 114 unwanted portions of the photoresist (FIG. 6). “Sandblasting” is defined herein to comprise any process in which particles are ejected towards a part. As a result, the particles need not be “sand.” Following the step of sandblasting 112, unwanted portions of the photoresist 202 are removed 114 (FIG. 6) from the substrate 200. Depending on how the photoresist 202 is patterned, a separate step may not be needed to remove the unwanted portions of the photoresist 202 (e.g., depending on the process used to pattern the photoresist 202 patterning the photoresist 202 may cause the unwanted portions of the photoresist 202 to disintegrate or vaporize).

Unfortunately, during abrading 102, micro cracks 502 are formed in the channel 500 of the substrate 200 as shown in FIGS. 5 and 6. Further, the surface of the channel 500 may be roughened due to the abrading. Sometimes it is desirable to apply other materials, for example, a seal belt layer, on the abraded surface of the channel 500. However, the adhesion of these other materials to the channel 500 may be compromised by the roughness and the micro cracks 502 formed in the channel 500. Therefore, a seal between the desired layer and the channel 500, and in particular, a hermetic seal, is unlikely.

To overcome the micro cracks and surface roughness produced by an abrading technique such as sandblasting, the channel plate may be heated at an elevated temperature, preferably in an environment capable of containing air, nitrogen gas, or preferably, a mixture of nitrogen with water vapor. One type of environment may be a conventional furnace for heating glass substances. Continuing with the method of forming a channel plate as shown in FIG. 1, the substrate 200 is heated 104 to a temperature in the range between the annealing point and softening point of the substrate 200. If the substrate 200 is heated 104 in an environment containing a mixture of nitrogen with water vapor, the percentage of water vapor in the environment should be in the range of 10% to 25%, but about 5% below the saturation point. A maximum temperature in the range between the annealing point and softening point of the substrate 200 is preferred. This temperature is maintained for a period of time as will be described in greater detail below such that the micro cracks in the substrate 200 and channel 500 are healed by having the walls fuse together and the surface roughness of the substrate 200 is smoothed without significantly distorting the larger geometries of the substrate 200. The composition of the substrate 200 will determine the operative temperature required for healing micro cracks and smoothing surface roughness of the substrate. By way of example, the composition of the substrate 200 could be glass or ceramic. Glass can be thought of as a “supercooled” liquid. When heated, the viscosity decreases, but there is no sharp melting point. In the disclosed method, the glass is heated to the point where it becomes slightly liquid and to maintain the temperature at that point for an adequate period of time so that the micro cracks are healed and the surface roughness is smoothed.

If the substrate 200 is comprised of Pyrex® Brand 7740 glass, the substrate 200 may be heated to a maximum temperature in the range between the annealing point of 560° C. wherein the viscosity of the glass is 10¹³ poise and the softening point of 821° C. wherein the viscosity of the glass is 10^{7.6} poise.

If the substrate 200 is comprised of Corning® 1737 glass, the substrate 200 may be heated to a maximum temperature in the range between the annealing point of 721° C. wherein the viscosity of the glass is 10¹³ poise and the softening point of 975° C. wherein the viscosity of the glass is 10^{7.6} poise.

The composition of the substrate 200 will also determine the duration of time at which the substrate 200 may be heated at the maximum temperature in the range between the annealing point and the softening point of the substrate 200. Typically, the temperature is maintained between ten minutes and one hundred twenty minutes. This amount of time desensitizes the substrate 200 to heating and cooling ramp rates. The duration of time required to achieve a glass viscosity of 10^{9.4} poise, which is a viscosity value two-thirds (⅔) of the distance from the annealing point to the softening point on the log (viscosity) scale, is approximately ten minutes. If the desired effect is not achieved after ten minutes (too much slumping or no visible change), the temperature and time may be adjusted. However, if the effect is close to the desired one, the time only may be adjusted.

With respect to adjusting the time and temperature at which the substrate 200 is heated, if the substrate 200 is thick, it is not advisable to increase the temperature too quickly. The heating and cooling ramp rates are typically linear and about 20° C. to 40° C. per minute. A thick substrate (e.g., one having a thickness of about one millimeter or greater) should be heated and cooled at about 20° C. per minute. A thin substrate (e.g., one having a thickness of about one millimeter or less) may be heated and cooled at about 40° C. per minute.

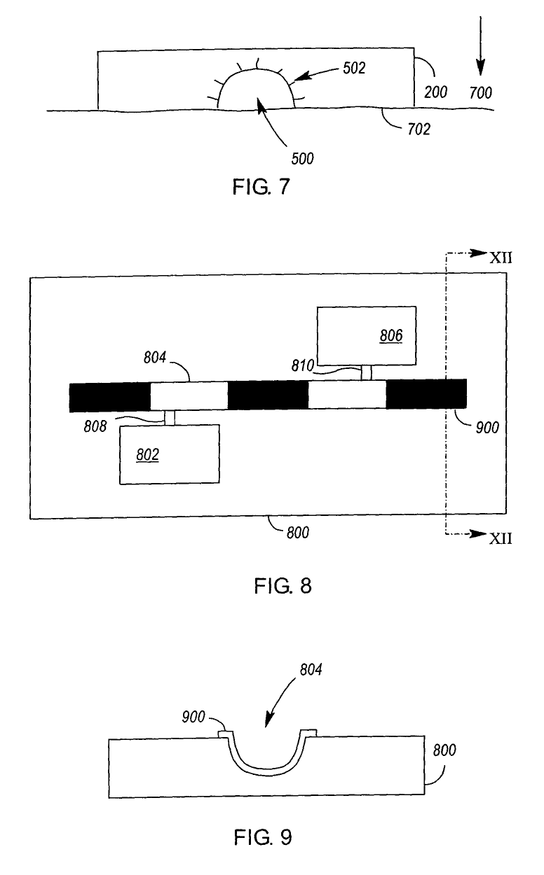

During heating, the substrate 200 may be supported on a flat, stable surface. By way of example, the substrate 200 may be supported on a polished, low porosity surface such as ceramic or graphite. The substrate 200 may be oriented with the channel 500 facing up as shown by arrow 600 in FIG. 6, or with the channel 500 facing down as shown by arrow 700 in FIG. 7. The orientation of the substrate 200 with the channel 500 facing up as shown by arrow 600 is preferred when heating individual substrates and not multiple substrates in a wafer format because any thickness non-uniformity in the wafer will be reflected after thermal processing as a wafer mating surface that is not flat. This will cause problems in wafer-to-wafer bonding to produce liquid metal micro switches (LIMMS), for example. If the substrates are thermally treated individually, it is unlikely that the thickness variation across a surface that small will be enough to cause a bonding problem due to flatness. A face-up orientation will probably provide a sufficiently smooth surface without channel sag. If the substrate 200 is oriented such that the channel 500 is facing down, the channel 500 may sag during heating. Further, an imprint of the supporting surface 702 may be embedded into the substrate 200 surface as shown in FIG. 7, if the supporting surface is not polished and of low porosity. Whether individual substrates or multiple substrate wafers are heated, and depending on which factor is more important, i.e., smooth mating surface or precise channel volume, either direction may be satisfactory if the heating process is carefully controlled. Continuing with the method disclosed in FIG. 1, the substrate 200 is removed from the heating environment for cooling 106 of the substrate 200.

The FIG. 1 method of forming channels in a substrate has a variety of useful applications. One application is the formation of channel plates such as that which is shown in FIG. 8. The channel plate 800 may be used in the manufacture of fluid-based switches such as liquid metal micro switches (LIMMS). FIG. 8 illustrates a channel plate 800 in which a plurality of channels 802, 804, 806, 808, 810 have been formed. In one embodiment, the channel plate 800 is produced by forming all of the channels 802-810 in accordance with the teachings of method 100. In another embodiment, the channel plate 800 is produced by forming only some of its channels in accordance with the teachings of method 100 (e.g., only the larger channels 802, 204, 806).

Optionally, portions of a channel plate 800 may be metallized (e.g., via sputtering or evaporating through one or more shadow masks, or via etching through a photoresist) for the purpose of creating “seal belts.” The creation of seal belts within a switching fluid channel provides additional surface areas to which a switching fluid may wet. This not only helps in latching the various states that a switching fluid can assume, but also helps to create a sealed chamber from which the switching fluid cannot escape, and within which the switching fluid may be more easily pumped (i.e., during switch state changes). Referring to FIG. 9, a seal belt 900 is shown deposited on channel 804. Using the FIG. 1 method, adhesion of the seal belt 900 is improved.

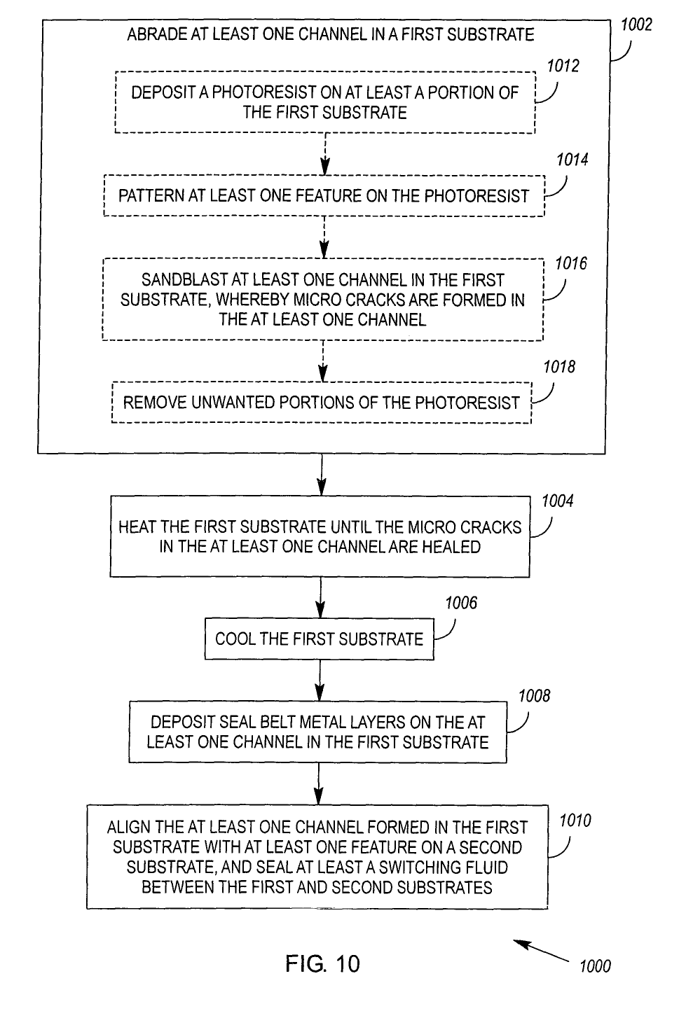

FIG. 10 illustrates a method 1000 for producing a switch. The method commences with the step of abrading 1002 at least one channel in a first substrate. The step of abrading 1002 could comprise the sandblasting process of FIGS. 2-6 as set forth in steps 1012-1018 of FIG. 10. Returning to the method of FIG. 10, the first substrate is then heated 1004 to a temperature in an environment containing nitrogen with 10% to 25% water vapor, but about 5% below the saturation point, until microcracks in the at least one channel are healed. The first substrate is then cooled 1006. The method continues with the steps of depositing 1008 seal belt metal layers on the at least one channel in the first substrate and aligning 1010 the at least one channel formed in the first substrate with at least one feature on a second substrate, thereby sealing at least a switching fluid between the first substrate and the second substrate.

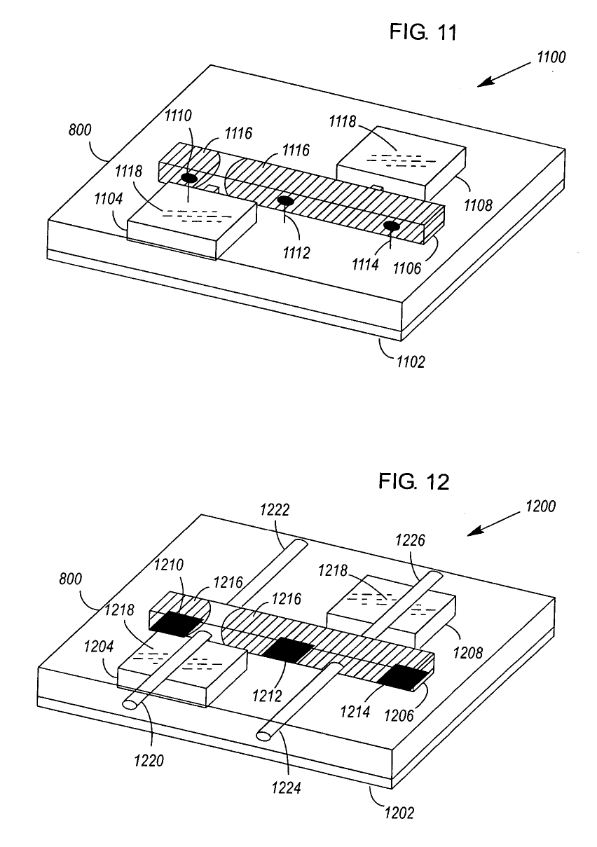

FIGS. 11 and 12 illustrate switches that may be produced according to the method of FIG. 10 and that might incorporate a channel plate such as that which is shown in FIG. 8. FIG. 11 illustrates a first exemplary embodiment of a switch 1100. The switch 1100 comprises a channel plate 800 defining at least a portion of a number of cavities 1104, 1106, 1108. The remaining portions of the cavities 104-1108, if any, may be defined by a substrate 1102 to which the channel plate 800 is mated and sealed. Exposed within one or more of the cavities are a plurality of electrodes 1110, 1112, 1114. A switching fluid 1116 (e.g., a conductive liquid metal such as mercury) held within one or more of the cavities serves to open and close at least a pair of the plurality of electrodes 1110-1114 in response to forces that are applied to the switching fluid 1116. An actuating fluid 1118 (e.g., an inert gas or liquid) held within one or more of the cavities serves to apply the forces to the switching fluid 1116.

In one embodiment of the switch 1100, the forces applied to the switching fluid 1116 result from pressure changes in the actuating fluid 1118. The pressure changes in the actuating fluid 1118 impart pressure changes to the switching fluid 1116, and thereby cause the switching fluid 1116 to change form, move, part, etc. In FIG. 11, the pressure of the actuating fluid 1118 held in cavity 1104 applies a force to part the switching fluid 1116 as illustrated. In this state, the rightmost pair of electrodes 1112, 1114 of the switch 1100 is coupled to one another. If the pressure of the actuating fluid 1118 held in cavity 1104 is relieved, and the pressure of the actuating fluid 1118 held in cavity 1108 is increased, the switching fluid 1116 can be forced to part and merge so that electrodes 1112 and 1114 are decoupled and electrodes 1110 and 1112 are coupled.

By way of example, pressure changes in the actuating fluid 1118 may be achieved by means of heating the actuating fluid 1118, or by means of piezoelectric pumping. The former is described in U.S. Pat. No. 6,323,447 of Kondoh et al. entitled “Electrical Contact Breaker Switch, Integrated Electrical Contact Breaker Switch, and Electrical Contact Switching Method.” The latter is described in U.S. patent application Ser. No. 10/137,691 of Marvin Glenn Wong filed May 2, 2002 and entitled “A Piezoelectrically Actuated Liquid Metal Switch.” Although the above referenced patent and patent application disclose the movement of a switching fluid by means of dual push/pull actuating fluid cavities, a single push/pull actuating fluid cavity might suffice if significant enough push/pull pressure changes could be imparted to a switching fluid from such a cavity. In such an arrangement, the channel plate for the switch could be constructed similarly to the channel plate 1100 disclosed herein.

The one or more channels 1102-1110 in the channel plate 1100 may be aligned with one or more features on the substrate 1102, and the channel plate 1100 may then be sealed to the substrate 1102, by means of adhesive or gasket material, for example. One suitable adhesive is Cytop™ (manufactured by Asahi Glass Co., Ltd. of Tokyo, Japan). Cytop™ comes with two different adhesion promoter packages, depending on the application. When a channel plate 1100 has an inorganic composition, Cytop™'s inorganic adhesion promoters should be used. Similarly, when a channel plate 1100 has an organic composition, Cytop™'s organic adhesion promoters should be used.

Additional details concerning the construction and operation of a switch such as that which is illustrated in FIG. 11 may be found in the afore-mentioned patent of Kondoh et al. and patent application of Marvin Glenn Wong.

FIG. 12 illustrates a second exemplary embodiment of a switch 1200. The switch 1200 comprises a channel plate 800 defining at least a portion of a number of cavities 1204, 1206, 1208. The remaining portions of the cavities 1204-1208, if any, may be defined by a substrate 1202 to which the channel plate 800 is sealed. Exposed within one or more of the cavities are a plurality of wettable pads 1210-1214. A switching fluid 1216 (e.g., a liquid metal such as mercury) is wettable to the pads 1210-1214 and is held within one or more of the cavities. The switching fluid 1216 serves to open and block light paths 1220/1222, 1224/1226 through one or more of the cavities, in response to forces that are applied to the switching fluid 1216. By way of example, the light paths may be defined by waveguides 1220-1226 that are aligned with translucent windows in the cavity 1206 holding the switching fluid. Blocking of the light paths 1220/1222, 1224/1226 may be achieved by virtue of the switching fluid 1216 being opaque. An actuation fluid 1218 (e.g., an inert gas or liquid) held within one or more of the cavities serves to apply the forces to the switching fluid 1216.

Forces may be applied to the switching and actuating fluids 1216, 1218 in the same manner that they are applied to the switching and actuating fluids 1116, 1118 in FIG. 12.

The channel plate 800 of the switch 1200 may have a plurality of channels 802-810 formed therein, as illustrated in FIG. 8. In one embodiment of the switch 1200, the first channel 804 in the channel plate 800 defines at least a portion of the one or more cavities 1206 that hold the switching fluid 1216.

A second channel or channels 802, 806 may be formed in the channel plate 800 so as to define at least a portion of the one or more cavities 1204, 1208 that hold the actuating fluid 1218.

A third channel or channels 808, 810 may be formed in the channel plate 800 so as to define at least a portion of one or more cavities that connect the cavities 1204-1208 holding the switching and actuating fluids 1216, 1218.

Additional details concerning the construction and operation of a switch such as that which is illustrated in FIG. 12 may be found in the afore-mentioned patent of Kondoh et al. and patent application of Marvin Glenn Wong. Furthermore, an adhesive or gasket layer, as well as seal belts, may be applied to the switch's channel plate 800 as described supra, and as shown in FIGS. 8 and 9.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method for forming a channel plate, comprising:
(a) abrading at least one channel in a substrate;
(b) heating the substrate to a temperature in the range between an annealing point and a softening point of the substrate; and
(c) cooling the substrate.

2. The method of claim 1, wherein the substrate is heated in an environment containing a mixture of nitrogen with water vapor.

3. The method of claim 2, wherein the percentage of water vapor in the environment in which the substrate is heated is in the range of 10% to 25%, but about 5% below the saturation point.

4. The method of claim 1, wherein the substrate is heated in an environment containing air.

5. The method of claim 1, wherein the substrate is heated in an environment containing nitrogen gas.

6. The method of claim 1, wherein the substrate comprises ceramic.

7. The method of claim 1, wherein the substrate comprises glass.

8. The method of claim 7, wherein the glass type is Corning® 1737 Glass.

9. The method of claim 8, wherein the substrate is heated to a temperature in the range of about 721° C. to 975° C.

10. The method of claim 9, wherein a maximum heating temperature is maintained for at least ten minutes.

11. The method of claim 7, wherein the glass type is Pyrex® Brand 7740 Glass.

12. The method of claim 11, wherein the substrate is heated to a temperature in the range of about 560° C. to 821° C.

13. The method of claim 12, wherein a maximum heating temperature is maintained for at least ten minutes.

14. The method of claim 1, wherein the substrate is heated to a temperature that heals micro cracks in the substrate while minimizing sagging of macro features of the substrate.

15. The method of claim 1, wherein the substrate is heated to a temperature that smoothes the surface of the substrate without disturbing macro features of the substrate.

16. The method of claim 1, wherein the substrate is heated for a period of time in the range of approximately ten to one hundred twenty minutes.

17. The method of claim 1, wherein the substrate is oriented with the at least one channel facing up when heated.

18. The method of claim 1, wherein the substrate is oriented with the at least one channel facing down when heated.

19. The method of claim 1, wherein the substrate is supported on a polished, low porosity surface during said heating.

20. The method of claim 1, wherein the substrate is heated in a furnace wherein the temperature is ramped from 25° C. at a rate of about 20° C. to 40° C. per minute.

21. The method of claim 20, wherein the substrate is cooled to 25° C. at a ramp rate of about 20° C. to 40° C. per minute.

22. A method for healing cracks in a switch substrate, comprising:
(a) heating the switch substrate to a temperature in the range between an annealing point and a softening point of the substrate; and
(b) cooling the substrate.

23. The method of claim 22, wherein the substrate is heated in an environment containing a mixture of nitrogen with water vapor.

24. The method of claim 23, wherein the percentage of water vapor in the environment in which the substrate is heated is in the range of about 10% to 25%, but about 5% below the saturation point.

25. A switch, produced by:
(a) abrading at least one channel in a first substrate;
(b) heating the first substrate until micro cracks in the at least one channel are healed;
(c) cooling the first substrate;
(d) depositing seal belt metal layers on the at least one channel in the first substrate; and
(e) aligning the at least one channel formed in the first substrate with at least one feature on a second substrate, and sealing at least a switching fluid between the first substrate and the second substrate.

26. The method of claim 25, wherein the first substrate is heated in an environment containing a mixture of nitrogen with water vapor.

27. The method of claim 26, wherein the percentage of water vapor in the environment in which the substrate is heated is in the range of about 10% to 25%, but about 5% below the saturation point.

28. The method of claim 25, wherein the step of abrading comprises;
(a) depositing a photoresist on the first substrate;
(b) patterning at least one feature on the photoresist;
(c) sandblasting at least one channel in the first substrate whereby micro cracks are formed in the at least one channel; and
(d) removing unwanted portions of the photoresist.
